(19) United States
(12) Patent Application Publication
(10) Pub. No.: US 2009/0020383 A1
(43) Pub. Date: Jan. 22, 2009

(54) DAMPED PART

(75) Inventors: Michael D. Hanna, West Bloomfield, MI (US); Mohan Sundar, Troy, MI (US); James G. Schroth, Troy, MI (US); Thomas C. Zebehazy, Rochester, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., DETROIT, MI (US)

(21) Appl. No.: 12/174,163

(22) Filed: Jul. 16, 2008

Related U.S. Application Data
(63) Continuation-in-part of application No. 11/554,234, filed on Oct. 30, 2006.
Application No. 11/554,234 is a continuation-in-part of application No. 11/475,756, filed on Jun. 27, 2006.
(60) Provisional application No. 60/950,904, filed on Jul. 20, 2007.

(51) Int. Cl. F16F 7/01

(52) U.S. Cl. 188/381

(57) ABSTRACT

A part including a body including a metal, and a frictional damping means, the frictional damping means comprising frictional surfaces in local contact but not bonded together, or the frictional damping means including a layer including at least one of particles, flakes, or fibers, the layer having a thickness ranging from about 1 μm to about 500 μm.

### CROSS-REFERENCE TO RELATED APPLICATIONS

This is a continuation-in-part of U.S. patent application Ser. No. 11/554,234, filed Oct. 30, 2006, and is a continuation-in-part of U.S. patent application Ser. No. 11/475,756, filed Jun. 27, 2006. This application claims the benefit of U.S. Provisional Application No. 60/950,904, filed Jul. 20, 2007.

### TECHNICAL FIELD

The field to which this disclosure generally relates includes a part that provides frictional damping.

### BACKGROUND

Parts subjected to vibration may produce unwanted or undesirable vibrations. Similarly, a part or component may be set into motion at an undesirable frequency and/or amplitude and for a prolonged period. For example, parts such as brake rotors, brackets, pulleys, brake drums, transmission housings, gears, and other parts may contribute to noise that gets transmitted to the passenger compartment of a vehicle. In an effort to reduce the generation of this noise and thereby its transmission into the passenger compartment, a variety of techniques have been employed, including the use of polymer coatings on engine parts, sound absorbing barriers, and laminated panels having viscoelastic layers. The undesirable vibrations in parts or components may occur in a variety of other products including, but not limited to, sporting equipment, household appliances, manufacturing equipment such as lathes, milling/grinding/drilling machines, earth moving equipment, other nonautomotive components, and components that are subject to dynamic loads and vibration. These components can be manufactured through a variety of means including casting, machining, forging, die-casting, etc.

### SUMMARY OF EXEMPLARY EMBODIMENTS OF THE INVENTION

One embodiment of the invention provides a part including a body including a metal, and a frictional damping means, the frictional damping means comprising frictional surfaces in local contact but not bonded together, or the frictional damping means including a layer including at least one of particles, flakes, or fibers, the layer having a thickness ranging from about 1 μm to about 500 μm.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 illustrates a product according to one embodiment of the invention;

FIG. 2 illustrates a product according to one embodiment of the invention;

FIG. 3 is a sectional view with portions broken away of one embodiment of the invention including an insert;

FIG. 4 is a sectional view with portions broken away of one embodiment of the invention including two spaced apart frictional surfaces of a cast metal body portion;

FIG. 5 is a sectional view with portions broken away of one embodiment of the invention including an insert having a layer thereon to provide a frictional surface for damping;

FIG. 6 is a sectional view with portions broken away of one embodiment of the invention;

FIG. 7 is an enlarged view of one embodiment of the invention;

FIG. 8 is a sectional view with portions broken away of one embodiment of the invention;

FIG. 9 is an enlarged sectional view with portions broken away of one embodiment of the invention;

FIG. 10 is an enlarged sectional view with portions broken away of one embodiment of the invention;

FIG. 11 is an enlarged sectional view with portions broken away of one embodiment of the invention;

FIG. 12 illustrates one embodiment of the invention;

FIG. 13 is a sectional view with portions broken away of one embodiment of the invention;

FIG. 14 is a sectional view with portions broken away of one embodiment of the invention;

FIG. 15 is a plan view with portions broken away illustrating one embodiment of the invention;

FIG. 16 is a sectional view taken along line 16-16 of FIG. 15 illustrating one embodiment of the invention;

FIG. 17 is a sectional view with portions broken away illustrating one embodiment of the invention;

FIG. 18 is a sectional view, with portions broken away illustrating another embodiment of the invention;

FIG. 19 illustrates a product according to one embodiment of the invention;

FIG. 20A is a graph of the sound amplitude versus time for a rotor according to one embodiment of the invention;

FIG. 20B is a graph of the sound amplitude versus time for a rotor according to one embodiment of the invention;

FIG. 20C is a graph of the sound amplitude versus time for a rotor according to one embodiment of the invention;

FIG. 20D is a graph of the sound amplitude versus time for a rotor according to one embodiment of the invention;

FIG. 20E is a graph of the sound amplitude versus time for a rotor according to one embodiment of the invention;

FIG. 20F is a graph of the sound amplitude versus time for a rotor according to one embodiment of the invention;

FIG. 21A is a graph of the sound amplitude versus frequency for a rotor according to one embodiment of the invention;

FIG. 21B is a graph of the sound amplitude versus frequency for a rotor according to one embodiment of the invention;

FIG. 21C is a graph of the sound amplitude versus frequency for a rotor according to one embodiment of the invention;

FIG. 21D is a graph of the sound amplitude versus frequency for a rotor according to one embodiment of the invention; and

FIG. 21E is a graph of the sound amplitude versus frequency for a rotor according to one embodiment of the invention.

### DETAILED DESCRIPTION OF EXEMPLARY EMBODIMENTS

The following description of the embodiment(s) is merely exemplary in nature and is in no way intended to limit the invention, its application, or uses.

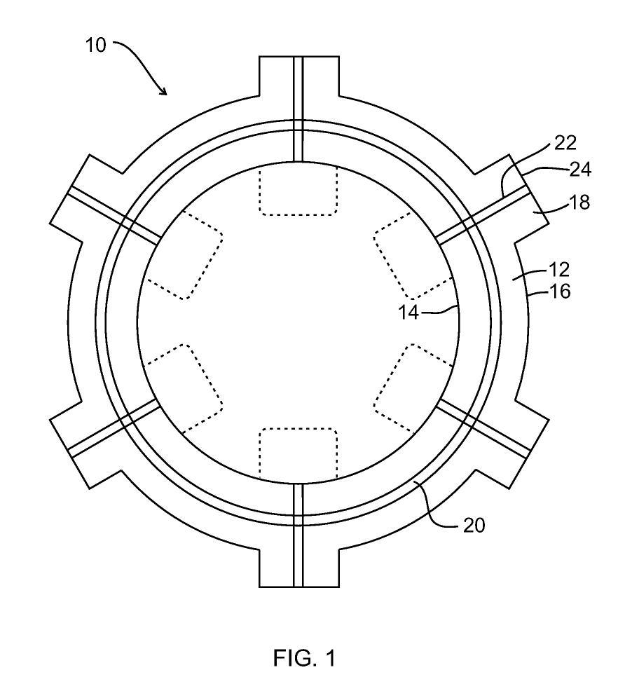

Referring to FIG. 1, an insert 10 is provided according to one embodiment of the invention. The insert 10 may provide damping in a part, for example, but not limited to, an automotive component. In various embodiments, the insert 10 may have various geometric configurations. In one embodiment, the insert 10 may have an annular body 12 comprising an inner edge 14 and an outer edge 16. The part into which the insert 10 is incorporated may be made from any of a variety of materials including, but not limited to, at least one of cast iron, steel, aluminum, titanium, or other metallic/non-metallic (ceramic or refractory) materials. The part into which the insert 10 is incorporated may include any part subject to vibration/dynamic loading including, for example, but not limited to a brake rotor, bracket, pulley, brake drum, transmission housing, gear, motor housing, shaft, bearing, engine, baseball bat, lathe machine, milling machine, drilling machine, or grinding machine.

In one embodiment, the insert 10 may include at least one tab 18, which may extend from at least one of the inner edge 14 or the outer edge 16 of the annular body 12. In FIG. 1, the tabs 18 extending from the inner edge 14 are shown in phantom. In one embodiment, the insert 10 may have a coating thereon. In another embodiment, the annular body 12 may have a coating, but the tabs 18 may not have the coating. In one embodiment, the insert can be without a coating.

According to one embodiment of the invention, the insert 10 may include an annular stiffening rib 20 in the annular body 12. During the process of manufacturing a part containing the insert 10, the tabs 18 may allow the insert 10 to be placed securely in the mold to manufacture the part. Two parts of a casting mold may clamp down on the tabs 18. The insert 10 may have sufficient rigidity to be loaded into the mold as one piece. The annular stiffening rib 20 may be approximately equidistant from the inner edge 14 and the outer edge 16. In another embodiment, the insert 10 may include a plurality of radial stiffening ribs 22, which may extend from the inner edge 14 of the annular body 12 to an outer edge 24 of the tabs 18.

Referring to FIG. 2, in one embodiment the at least one tab 18 may include a bent tab portion 30. The bent tab portion 30 may be perpendicular to the remainder of the tab 18, or the bent tab portion 30 may be at any suitable angle relative to the remainder of the tab 18. When using a vertical casting mold, the bent tab portion 30 may be used to hold the insert 10 in one part of a sand mold before closing the mold. In the horizontal casting process, the tabs 18 can be straight or bent if necessary. The number of tabs 18 can vary as needed.

In another embodiment, the annular body 12 may include a plurality of insert slots (not shown). The insert slots may be of any shape, for example, an oval, circle, square, rectangle, or triangle. The insert slots may allow the insert 10 to become segmented during the molding process, and each segment may be supported and prevented from moving too much by the tabs 18. Thus, the insert slots may prevent gross distortion of the insert 10 during the casting process.

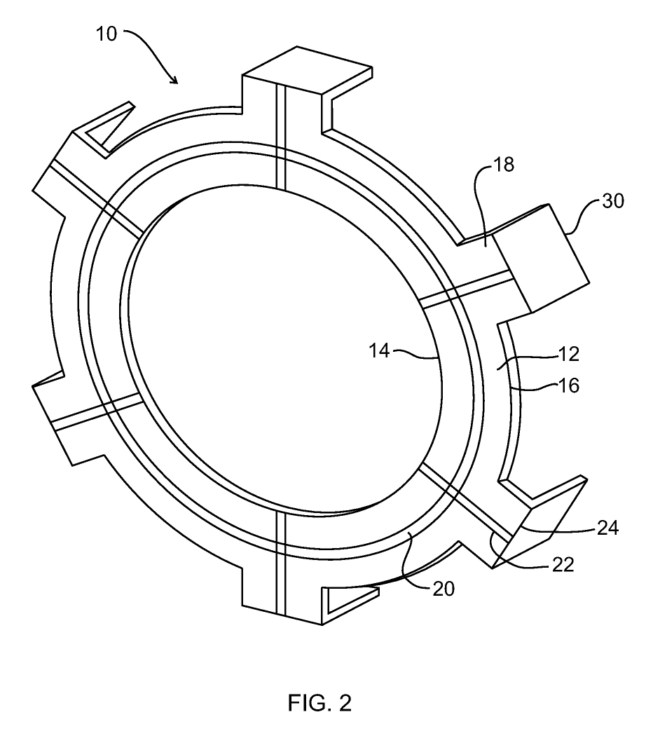

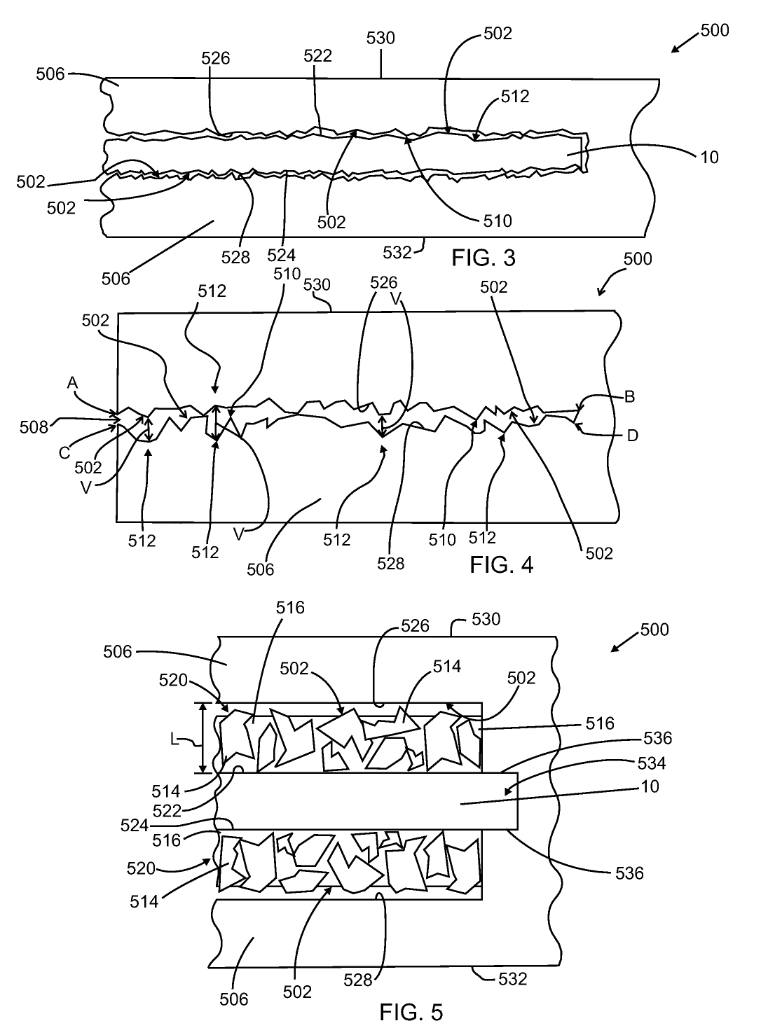

Referring to FIGS. 3-18, one embodiment of the invention includes a product or part 500 having a frictional damping means. The frictional damping means may be used in a variety of applications including, but not limited to, applications where it is desirable to reduce noise associated with a vibrating part or reduce the vibration amplitude and/or duration of a part that is struck, dynamically loaded, excited, or set in motion. In one embodiment the frictional damping means may include an interface boundary conducive to frictionally damping a vibrating part. In one embodiment the damping means may include frictional surfaces 502 constructed and arranged to move relative to each other and in frictional contact, so that vibration of the part is dissipated by frictional damping due to the frictional movement of the surfaces 502 against each other.

According to various illustrative embodiments of the invention, frictional damping may be achieved by the movement of the frictional surfaces 502 against each other. The movement of frictional surfaces 502 against each other may include the movement of: surfaces of a body 506 of the part against each other; a surface of the body 506 of the part against a surface of the insert 10; a surface of the body 506 of the part against a layer 520; a surface of the insert 10 against the layer 520; a surface of the body 506 of the part against particles 514, flakes, or fibers; a surface of the insert 10 against the particles 514, flakes, or fibers; or by frictional movement of the particles 514, flakes, or fibers against each other or against remaining binder material.

In embodiments wherein the frictional surface 502 is provided as a surface of the body 506 or the insert 10 or the layer 520 over one of the same, the frictional surface 502 may have a minimal area over which frictional contact may occur that may extend in a first direction a minimum distance of 0.1 mm and/or may extend in a second (generally traverse) direction a minimum distance of 0.1 mm. In one embodiment the insert 10 may be an annular body and the area of frictional contact on a frictional surface 502 may extend in an annular direction a distance ranging from about 20 mm to about 1000 mm and in a transverse direction ranging from about 10 mm to about 75 mm. The frictional surface 502 may be provided in a variety of embodiments, for example, as illustrated in FIGS. 3-18.

Referring again to FIG. 3, in another embodiment of the invention one or more of outer surfaces 522, 524 of the insert 10 or surfaces 526, 528 of the body 506 of the part 500 may include a relatively rough surface including a plurality of peaks 510 and valleys 512 to enhance the frictional damping of the part. In one embodiment, the surface of the insert 10 or the body 506 may be abraded by sandblasting, glass bead blasting, water jet blasting, chemical etching, machining or the like.

As shown in FIG. 4, in one embodiment one frictional surface 502 (for example extending from points A-B) may be a first surface of the body 506 of the part 500 positioned adjacent to a second frictional surface 502 (for example extending from points C-D) of the body 506. The body 506 may include a relatively narrow slot-like feature 508 formed therein so that at least two of the frictional surfaces 502 defining the slot-like feature 508 may engage each other for frictional movement during vibration of the part to provide frictional damping of the part 500. In various embodiments of the invention, the slot-like feature 508 may be formed by machining the cast part, or by using a sacrificial casting insert that may be removed after the casting by, for example, etching or machining. In one embodiment a sacrificial insert may be used that can withstand the temperature of the molten metal during casting but is more easily machined than the cast metal. Each frictional surface 502 may have a plurality of peaks 510 and a plurality of valleys 512. The depth as indicated by line V of the valleys 512 may vary with embodiments. In various embodiments, the average of the depth V of the valleys 512 may range from about 1 μm-500 μm, 50 μm-260 μm, 100 μm-160 μm or variations of these ranges. However, for all cases there is local contact between the opposing frictional surfaces 502 during component operation for frictional damping to occur.

In another embodiment of the invention the damping means or frictional surface 502 may be provided by particles 514, flakes, or fibers provided on at least one face of the insert 10 or a surface of the body 506 of the part 500. The particles 514, flakes, or fibers may have an irregular shape (e.g., not smooth) to enhance frictional damping, as illustrated in FIG. 12. One embodiment of the invention may include the layer 520 including the particles 514, flakes, or fibers which may be bonded to each other or to a surface of the body 506 of the part or a surface of the insert 10 due to the inherent bonding properties of the particles 514, flakes, or fibers. For example, the bonding properties of the particles 514, flakes, or fibers may be such that the particles 514, flakes, or fibers may bind to each other or to the surfaces of the body 506 or the insert 10 under compression. In another embodiment of the invention, the particles 514, flakes, or fibers may be treated to provide a coating thereon or to provide functional groups attached thereto to bind the particles, flakes, or fibers together or attach the particles, flakes, or fibers to at least one of a surface of the body 506 or a surface of the insert 10. In another embodiment of the invention, the particles 514, flakes, or fibers may be embedded in at least one of the body 506 of the part or the insert 10 to provide the frictional surface 502 (FIGS. 7-8).

In embodiments wherein at least a portion of the part 500 is manufactured such that the insert 10 and/or the particles 514, flakes, or fibers are exposed to the temperature of a molten material such as in casting, the insert 10 and/or particles 514, flakes, or fibers may be made from materials capable of resisting flow or resisting significant erosion during the manufacturing. For example, the insert 10 and/or the particles 514, flakes, or fibers may include refractory materials capable of resisting flow or that do not significantly erode at temperatures above 600° C., above 1300° C., or above 1500° C. When molten material, such as metal, is cast around the insert 10 and/or the particles 514, the insert 10 or the particles 514 should not be wet by the molten material so that the molten material does not bond to the insert 10 or layer 520 at locations wherein a frictional surface 502 for providing frictional damping is desired.

Illustrative examples of suitable particles 514, flakes, or fibers include, but are not limited to, particles, flakes, or fibers including silica, alumina, graphite with clay, silicon carbide, silicon nitride, cordierite (magnesium-iron-aluminum silicate), mullite (aluminum silicate), zirconia (zirconium oxide), phyllosilicates, or other high-temperature-resistant particles, flakes, or fibers. In one embodiment of the invention the particles 514 may have a length along the longest dimension thereof ranging from about 1 μm-500 μm, or 10 μm-250 μm.

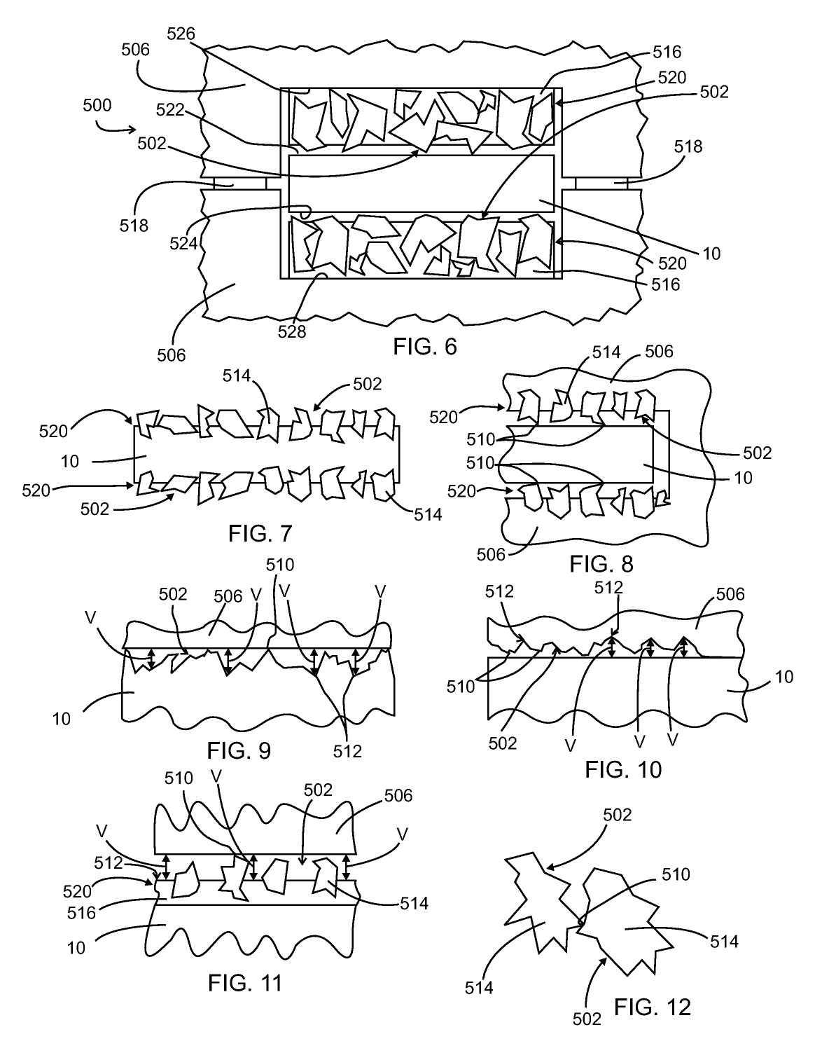

In embodiments wherein the part 500 is made using a process wherein the insert 10 and/or the particles 514, flakes, or fibers are not subjected to relatively high temperatures associated with molten materials, the insert 10 and/or particles 514, flakes, or fibers may be made from a variety of other materials including, but not limited to, non-refractory polymeric materials, ceramics, composites, wood or other materials suitable for frictional damping. For example, such non-refractory materials may also be used (in additional to or as a substitute for refractory materials) when two portions of the body 506 of the part 500 are held together mechanically by a locking mechanism, or by fasteners, or by adhesives, or by welding 518, as illustrated in FIG. 6.

In another embodiment of the invention, the layer 520 may be a coating over the body 506 of the part or the insert 10. The coating may include a plurality of particles 514, flakes, or fibers which may be bonded to each other and/or to the surface of the body 506 of the part or the insert 10 by an inorganic or organic binder 516 (FIGS. 5-6, 11) or other bonding materials. Illustrative examples of suitable binders include, but are not limited to, epoxy resins, phosphoric acid binding agents, calcium aluminates, sodium silicates, wood flour, or clays. In another embodiment of the invention the particles 514, flakes, or fibers may be held together and/or adhered to the body 506 or the insert 10 by an inorganic binder. In one embodiment, the coating may be deposited on the insert 10 or body 506 as a liquid dispersed mixture of alumina-silicate-based, organically bonded refractory mix.

In another embodiment, the coating may include at least one of alumina or silica particles, mixed with a lignosulfonate binder, cristobalite (SiO₂), quartz, or calcium lignosulfonate. The calcium lignosulfonate may serve as a binder. In one embodiment, the coating may include IronKote. In one embodiment, a liquid coating may be deposited on a portion of the insert and may include high temperature Ladle Kote 310B. In another embodiment, the coating may include at least one of clay, Al₂O₃, SiO₂, a graphite and clay mixture, silicon carbide, silicon nitride, cordierite (magnesium-iron-aluminum silicate), mullite (aluminum silicate), zirconia (zirconium oxide), or phyllosilicates. In one embodiment, the coating may comprise a fiber such as ceramic or mineral fibers.

When the layer 520 including particles 514, flakes, or fibers is provided over the insert 10 or the body 506 of the part the thickness L (FIG. 5) of the layer 520, particles 514, flakes, and/or fibers may vary. In various embodiments, the thickness L of the layer 520, particles 514, flakes, and/or fibers may range from about 1 μm-500 μm, 10 μm-400 μm, 30 μm-300 μm, 30 μm-40 μm, 40 μm-100 μm, 100 μm-120 μm, 120 μm-200 μm, 200 μm-300 μm, 200 μm-250 μm, or variations of these ranges.

In yet another embodiment of the invention the particles 514, flakes, or fibers may be temporarily held together and/or to the surface of the insert 10 by a fully or partially sacrificial coating. The sacrificial coating may be consumed by molten metal or burnt off when metal is cast around or over the insert 10. The particles 514, flakes, or fibers are left behind trapped between the body 506 of the cast part and the insert 10 to provide a layer 520 consisting of the particles 514, flakes, or fibers or consisting essentially of the particles 514, flakes, or fibers.

The layer 520 may be provided over the entire insert 10 or only over a portion thereof. In one embodiment of the invention the insert 10 may include a tab 534 (FIG. 5). For example, the insert 10 may include an annular body portion and a tab 534 extending radially inward or outward therefrom. In one embodiment of the invention at least one wettable surface 536 of the tab 534 does not include a layer 520 including particles 514, flakes, or fibers, or a wettable material such as graphite is provided over the tab 534, so that the cast metal is bonded to the wettable surface 536 to attach the insert 10 to the body 506 of the part 500 but still allow for frictional damping over the remaining insert surface which is not bonded to the casting.

In one embodiment of the invention at least a portion of the insert 10 is treated or the properties of the insert 10 are such that molten metal will not wet or bond to that portion of the insert 10 upon solidification of the molten metal. According to one embodiment of the invention at least one of the body 506 of the part or the insert 10 includes a metal, for example, but not limited to, aluminum, steel, stainless steel, cast iron, any of a variety of other alloys, or metal matrix composite including abrasive particles. In one embodiment of the invention the insert 10 may include a material such as a metal having a higher melting point than the melting point of the molten material being cast around a portion thereof.

In one embodiment the insert 10 may have a minimum average thickness of 0.2 mm and/or a minimum width of 0.1 mm and/or a minimum length of 0.1 mm. In another embodiment the insert 10 may have a minimum average thickness of 0.2 mm and/or a minimum width of 2 mm and/or a minimum length of 5 mm. In other embodiments the insert 10 may have a thickness ranging from about 0.1-20 mm, 0.1-6.0 mm, or 1.0-2.5 mm, or ranges therebetween.

Referring now to FIGS. 9-11, again the frictional surface 502 may have a plurality of peaks 510 and a plurality of valleys 512. The depth as indicated by line V of the valleys 512 may vary with embodiments. In various embodiments, the average of the depth V of the valleys 512 may range from about 1 μm-500 μm, 50 μm-260 μm, 100 μm-160 μm or variations of these ranges. However, for all cases there is local contact between the body 506 and the insert 10 during component operation for frictional damping to occur.

In other embodiments of the invention improvements in the frictional damping may be achieved by adjusting the thickness (L, as shown in FIG. 5) of the layer 520, or by adjusting the relative position of opposed frictional surfaces 502 or the average depth of the valleys 512 (for example, as illustrated in FIG. 4).

In one embodiment the insert 10 is not pre-loaded or under pre-tension or held in place by tension. In one embodiment the insert 10 is not a spring. Another embodiment of the invention includes a process of casting a material comprising a metal around an insert 10 with the proviso that the frictional surface 502 portion of the insert used to provide frictional damping is not captured and enclosed by a sand core that is placed in the casting mold. In various embodiments the insert 10 or the layer 520 includes at least one frictional surface 502 or two opposite friction surfaces 502 that are completely enclosed by the body 506 of the part. In another embodiment the layer 520 including the particles 514, flakes, or fibers that may be completely enclosed by the body 506 of the part or completely enclosed by the body 506 and the insert 10, and wherein at least one of the body 506 or the insert 10 comprises a metal or consists essentially of a metal. In one embodiment of the invention the layer 520 and/or insert 10 does not include or is not carbon paper or cloth.

Referring again to FIGS. 3-6, in various embodiments of the invention the insert 10 may include a first face 522 and an opposite second face 524 and the body 506 of the part may include a first inner face 526 adjacent the first face 522 of the insert 10 constructed to be complementary thereto, for example nominally parallel thereto. The body 506 of the part includes a second inner face 528 adjacent to the second face 524 of the insert 10 constructed to be complementary thereto, for example parallel thereto. The body 506 may include a first outer face 530 overlying the first face 522 of the insert 10 constructed to be complementary thereto, for example parallel thereto. The body 506 may include a first outer face 532 overlying the second face 524 of the insert 10 constructed to be complementary thereto, for example parallel thereto. However, in other embodiments of the invention the outer faces 530, 532 of the body 506 are not complementary to associated faces 522, 524 of the insert 10. When the damping means is provided by a narrow slot-like feature 508 formed in the body 506 of the part 500, the slot-like feature 508 may be defined in part by a first inner face 526 and a second inner face 528 which may be constructed to be complementary to each other, for example parallel to each other. In other embodiments the surfaces 526 and 528; 526 and 522; or 528 and 524 are mating surfaces but not parallel to each other.

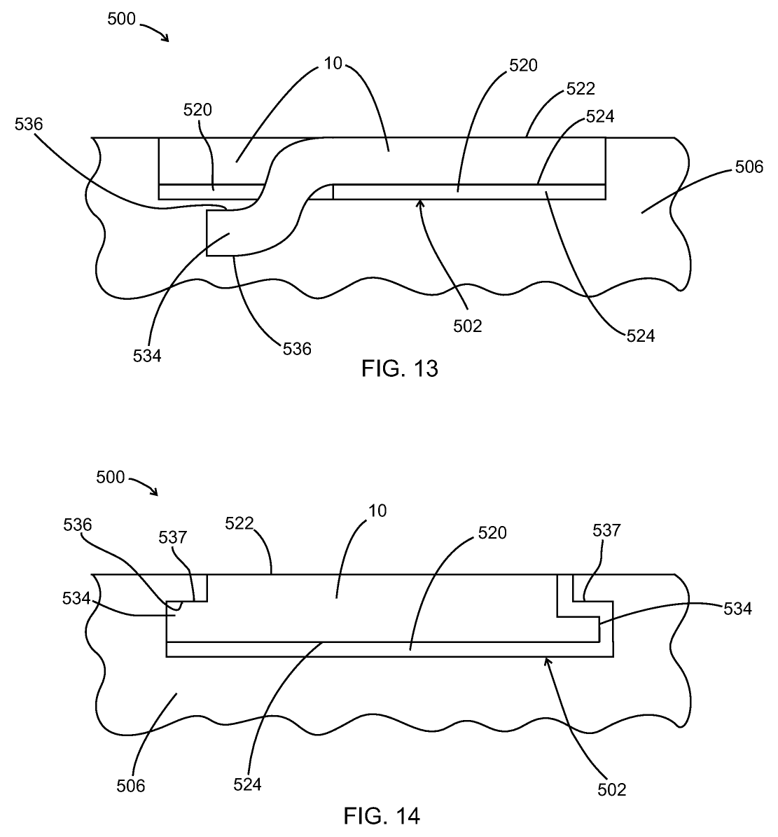

Referring to FIGS. 13-14, in one embodiment of the invention the insert 10 may be an inlay wherein a first face 522 thereof is not enclosed by the body 506 of the part. The insert 10 may include a tang or tab 534 which may be bent downward as shown in FIG. 13. In one embodiment of the invention a wettable surface 536 may be provided that does not include a layer 520 including particles 514, flakes, or fibers, or a wettable material such as graphite is provided over the tab 534, so that the cast metal is bonded to the wettable surface 536 to attach the insert 10 to the body of the part but still allow for frictional damping on the non-bonded surfaces. A layer 520 including particles 514, flakes, or fibers may underlie the portion of the second face 524 of the insert 10 not used to make the bent tab 534.

In another embodiment the insert 10 includes a tab 534 which may be formed by machining a portion of the first face 522 of the insert 10 (FIG. 14). The tab 534 may include a wettable surface 536 having cast metal bonded thereto to attach the insert 10 to the body of the part but still allow for friction damping by way of the non-bonded surfaces. A layer 520 including particles 514, flakes, or fibers may underlie the entire second face 524 or a portion thereof. In other embodiments of the invention all surfaces including the tabs 534 may be non-wettable, for example by way of a coating 520 thereon, and features of the body portion 506 such as, but not limited to, a shoulder 537 may be used to hold the insert 10 in place.

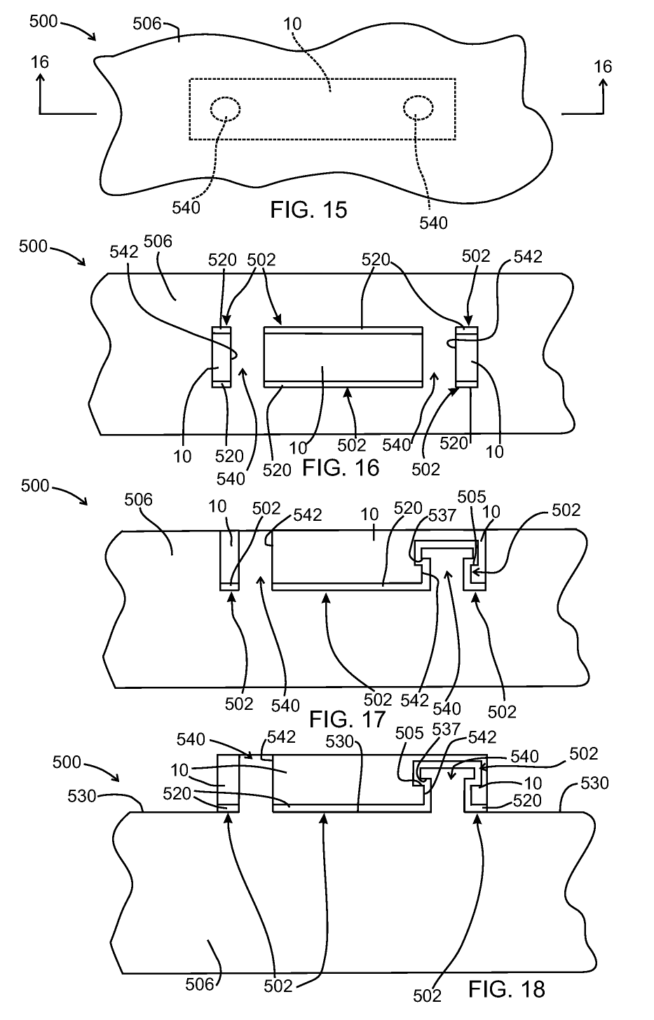

Referring now to FIG. 15, one embodiment of the invention may include a part 500 having a body portion 506 and an insert 10 enclosed by the body part 506. The insert 10 may include through holes formed therein so that a stake or post 540 extends into or through the insert 10.

Referring to FIG. 16, which is a sectional view of FIG. 15 taken along line 16-16, in one embodiment of the invention a layer 520 including a plurality of particles 514, flakes, or fibers (not shown) may be provided over at least a portion of the insert 10 to provide a frictional surface 502 and to prevent bonding thereto by cast metal. The insert 10 including the layer 520 may be placed in a casting mold and molten metal may be poured into the casting mold and solidified to form the post 540 extending through the insert 10. An inner surface 542 defining the through hole of the insert 10 may be free of the layer 520 or may include a wettable material thereon so that the post 540 is bonded to the insert 10. Alternatively, in another embodiment the post 504 may not be bonded the insert 10 at the inner surface 542. The insert 10 may include a feature such as, but not limited to, a shoulder 505 and/or the post 540 may include a feature such as, but not limited to, a shoulder 537 to hold the insert in place.

Referring now to FIG. 17, in another embodiment, the insert may be provided as an inlay in a casting including a body portion 506 and may include a post 540 extending into or through the insert 10. The insert 10 may be bonded to the post 540 to hold the insert in place and still allow for frictional damping. In one embodiment of the invention the insert 10 may include a recess defined by an inner surface 542 of the insert 10 and a post 540 may extend into the insert 10 but not extend through the insert 10. In one embodiment the post 504 may not be bonded to the insert 10 at the inner surface 542. The insert 10 may include a feature such as, but not limited to, a shoulder 505 and/or the post 540 may include a feature such as, but not limited to, a shoulder 537 to hold the insert in place.

Referring now to FIG. 18, in another embodiment of the invention, an insert 10 or substrate may be provided over an outer surface 530 of the body portion 506. A layer 520 may or may not be provided between the insert 10 and the outer surface 530. The insert 10 may be constructed and arranged with through holes formed therethrough or a recess therein so that cast metal may extend into or through the insert 10 to form a post 540 to hold the insert in position and still allow for frictional damping. The post 540 may or may not be bonded to the insert 10 as desired. The post 540 may extend through the insert 10 and join another portion of the body 506 if desired.

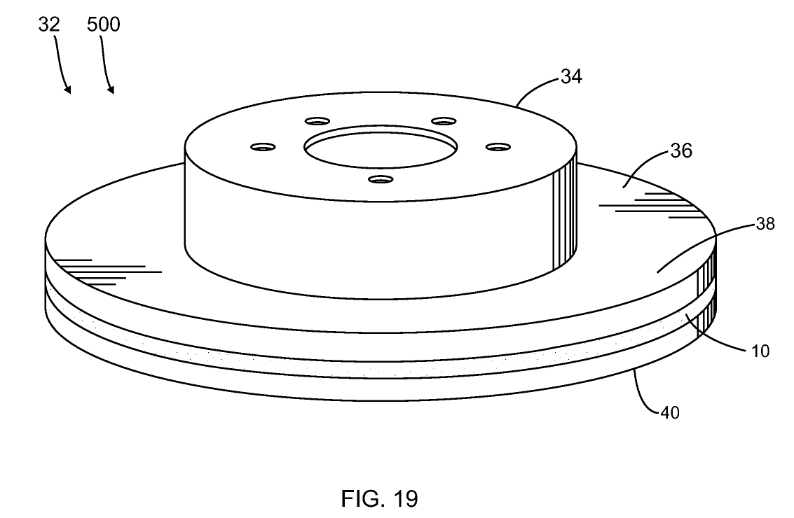

In various embodiments, the insert 10 with or without the layer 520 or coating may be incorporated into any suitable part 500 to provide frictional damping to reduce or eliminate vibrations, for example noise. The part 500 with the insert 10 may be manufactured in any suitable manner. As an example of a suitable part 500, in one embodiment the insert 10 is incorporated into an automobile part such as a rotor assembly 32 (FIG. 19). The rotor assembly 32 may include a hub portion 34, a annular portion 36, and the insert 10. The annular portion 36 may include a first brake pad face 38 and a second brake pad face 40. The insert 10 may be positioned between the first brake pad face 38 and the second brake pad face 40. In various embodiments, the rotor assembly 32 may be vented or un-vented.

The part including the insert 10, for example the rotor assembly 32 including the insert 10, may be manufactured in a variety of ways. For example, in one embodiment the insert may be placed in a slotted groove of a rotor. In another embodiment, the insert 10 may be encapsulated between two halves of the rotor. In another embodiment, the insert may be placed inside a tube or other means of closure and molten metal may be cast around the tube to form the rotor assembly 32. In another embodiment, the rotor may be cast around the insert 10. The casting process may be vertical or horizontal. In a vertical casting process, the insert 10 may be located on a sand mold using an automated setting device and/or placed using a core mold. The tabs 18 may be used for placement and securing of the insert 10 in the mold and for maintaining insert stability during the casting process. In a horizontal casting process, the insert 10 may rest on the lower half of a sand mold.

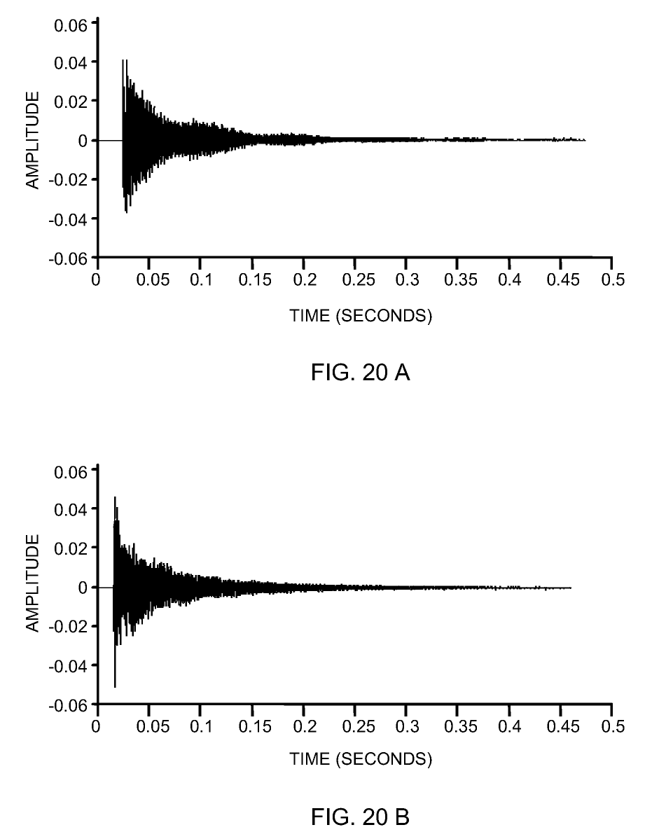

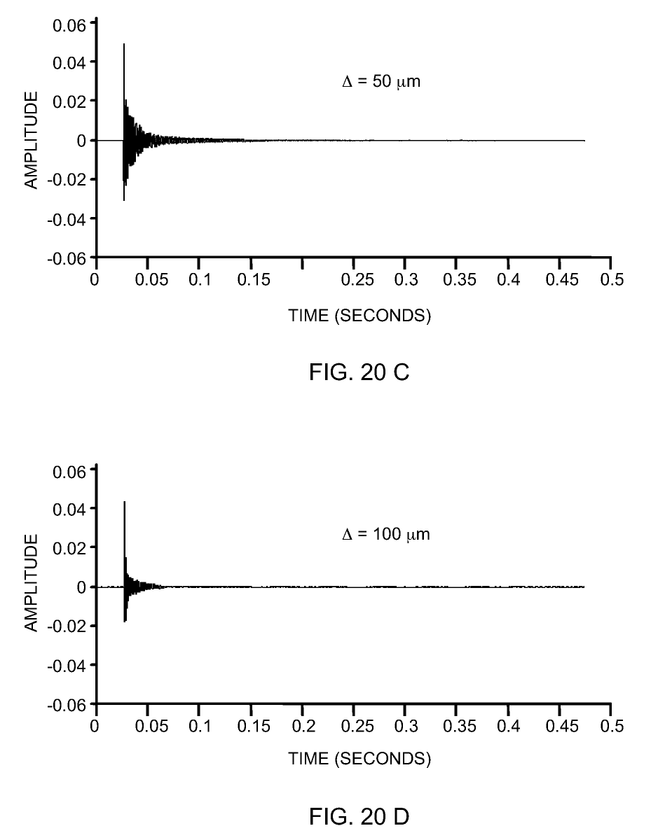

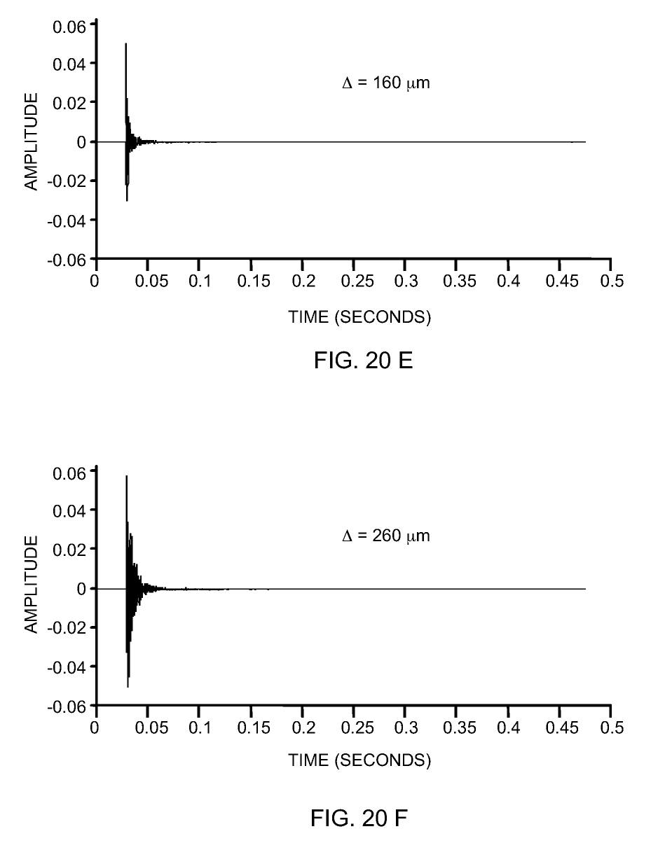

Referring to FIGS. 20A-F the extent of sound damping was determined for various configurations of a rotor after being struck with a hammer. Using a single brake rotor prototype and an insert where appropriate, design modifications were incorporated and measured for a variety of configurations including a solid rotor with no insert, a slotted rotor with no insert, and a slotted rotor with an insert and varying values of delta. Delta is the nominal average difference in the dimensions of the width of the slot and the thickness of the insert. Delta is an average measurement because the insert and body surfaces there is some local contact between the insert and the body for every value of delta identified. FIG. 20A is a graph of the sound amplitude versus time for a solid rotor with no insert. FIG. 20B is a graph of the sound amplitude versus time for a slotted rotor with no insert. FIG. 20C is a graph of the sound amplitude versus time for a slotted rotor with an un-coated insert and wherein delta is 50 μm. FIG. 20D is a graph of the sound amplitude versus time for a slotted rotor with an un-coated insert and wherein delta is 100 μm. FIG. 20E is a graph of the sound amplitude versus time for a slotted rotor with an un-coated insert and wherein delta is 160 μm. FIG. 20F is a graph of the sound amplitude versus time for a slotted rotor with an un-coated insert and wherein delta is 260 μm. As can be appreciated from these figures, the un-coated insert wherein delta is 100 μm or 160 μm provided improved sound damping.

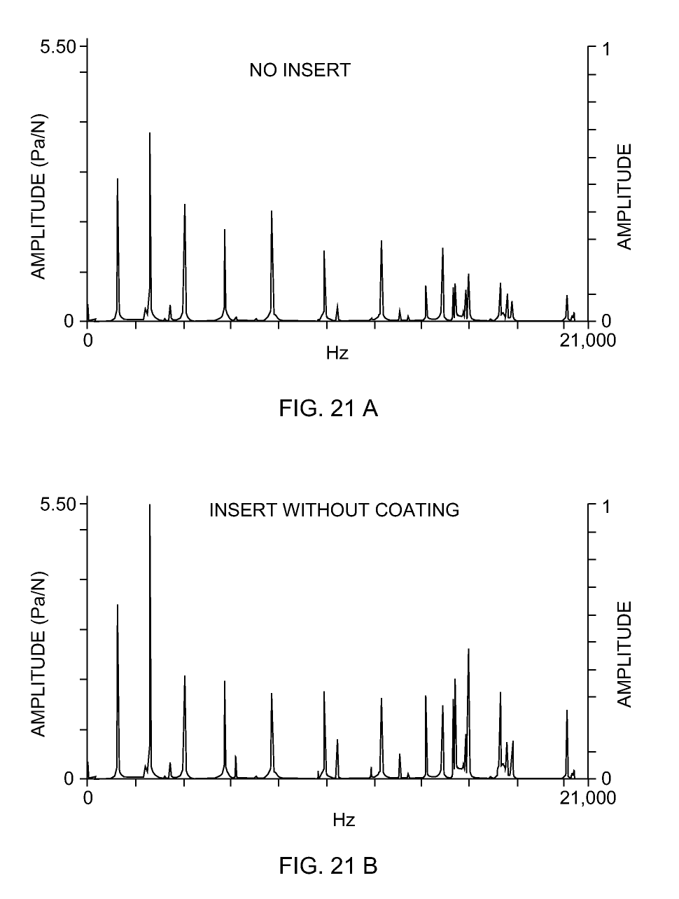

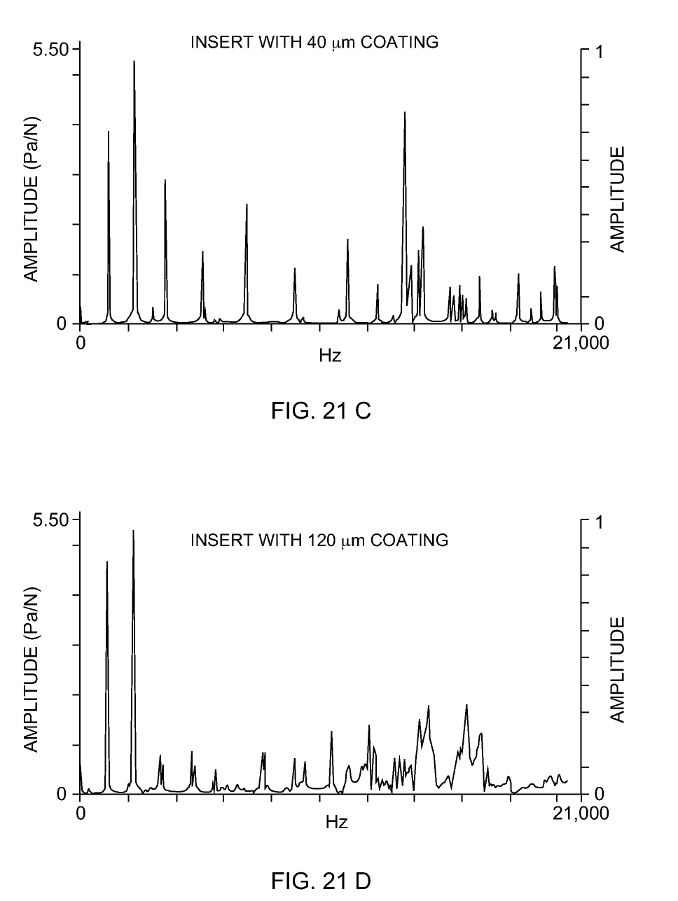

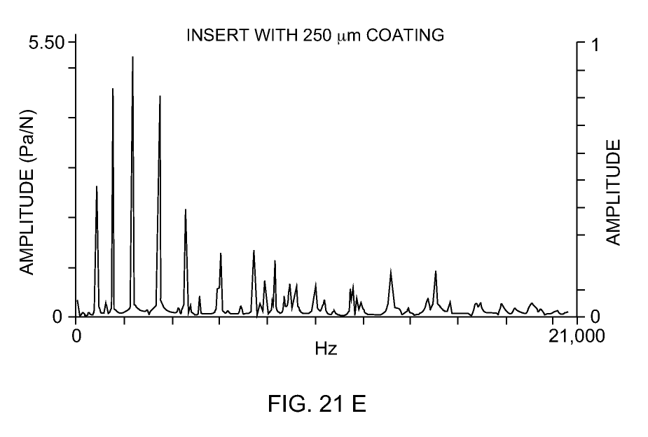

Referring to FIGS. 21A-E, the extent of sound damping was determined for various configurations of a rotor after being struck with a hammer. The same rotor geometry and the same insert geometry were used for each configuration of FIGS. 21A-E, with the thickness of the coating on the insert adjusted as indicated hereafter. The thickness of the coating as indicated is an average measurement. FIG. 21A is a graph of the sound amplitude versus frequency for a solid rotor with no insert. FIG. 21B is a graph of the sound amplitude versus frequency for a rotor including an un-coated insert. FIG. 21C is a graph of the sound amplitude versus frequency for a rotor including an insert with a 40 μm thick coating. FIG. 21D is a graph of the sound amplitude versus frequency for a rotor including an insert with a 120 μm thick coating. FIG. 21E is a graph of the sound amplitude versus frequency for a rotor including an insert with a 250 μm thick coating. The impact of the noise damping may be more clear in the high frequency domain which is associated with squeal. As can be appreciated from these figures, the insert with a 250 μm thick coating exhibits improved sound damping at the higher frequencies.

Additional test results are set forth in Table 1 below. Table 1 shows the frictional damping characteristics of various inserts. Delta is the nominal average difference in the dimensions of the width of the slot and the thickness of the insert.

TABLE 1

| Insert With Coating in | | Insert Without Coating in Part | |
|---|---|---|---|
| Cast-in-Place Part | | With Slotted Groove | |
| Coating | Frictional | | Frictional |
| Thickness | Damping | Delta | Damping |
| No insert | No damping | No insert | No damping |
| Insert with no | No damping | Insert with delta ≈ | Little damping |
| coating | | 0 μm | |
| Insert with | Little damping | Insert with delta = | Little damping |
| coating of | | about 50 μm | |
| 30-40 μm | | | |
| Insert with | Moderate | Insert with delta = | Excellent |
| coating of | damping | about 100 μm | damping |
| 100-120 μm | | | |
| Insert with | Excellent | Insert with delta = | Excellent |
| coating of | damping | about 160 μm | damping |
| 200-250 μm | | | |
| | | Insert with delta = | Little damping |
| | | about 250 μm | |

In the test associated with Table 1 the use of an insert with no coating was conducted such that the insert became welded (or bonded) to the cast portion of the part. In the test with the insert placed in a slotted groove with a delta of approximately 0 μm, the insert was not welded (or bonded) to the remaining portion of the part.

When the term “over,” “overlying,” overlies,” “under,” “underlying,” or “underlies” is used herein to describe the relative position of a first layer or component with respect to a second layer or component such shall mean the first layer or component is directly on and in direct contact with the second layer or component or that additional layers or components may be interposed between the first layer or component and the second layer or component.

The above description of embodiments of the invention is merely exemplary in nature and, thus, variations thereof are not to be regarded as a departure from the spirit and scope of the invention.

What is claimed is:

1. A product comprising:
a part comprising a body comprising a metal, and a frictional damping means, the frictional damping means comprising frictional surfaces in local contact but not bonded together, or the frictional damping means comprising a layer comprising at least one of particles, flakes, or fibers, the layer having a thickness ranging from about 1 μm to about 500 μm.

2. A product as set forth in claim 1 wherein the frictional damping means comprises an insert.

3. A product as set forth in claim 2 wherein the insert comprises an annular body.

4. A product as set forth in claim 2 wherein the insert comprises at least one of aluminum, steel, stainless steel, cast iron, any of a variety of other alloys, or metal matrix composites including abrasive particles.

5. A product as set forth in claim 2 wherein the frictional surfaces in local contact comprise a surface of the insert and a surface of the body.

6. A product as set forth in claim 1 wherein the thickness of the layer is about 10 μm to about 400 μm.

7. A product as set forth in claim 1 wherein the thickness of the layer is about 30 μm to about 300 μm.

8. A product as set forth in claim 1 wherein the thickness of the layer is about 20 μm to about 40 μm.

9. A product as set forth in claim 1 wherein the thickness of the layer is about 100 μm to about 120 μm.

10. A product as set forth in claim 1 wherein the thickness of the layer is about 200 μm to about 250 μm.

11. A product as set forth in claim 1 wherein the frictional surfaces comprise a plurality of peaks and valleys and wherein the average depth of the valleys ranges from about 1-500 μm on average.

12. A product as set forth in claim 1 wherein the frictional surfaces comprise a plurality of peaks and valleys and wherein the average depth of the valleys ranges from about 100-160 μm on average.

13. A product as set forth in claim 1 wherein the layer comprises at least one of silica, alumina, graphite with clay, silicon carbide, silicon nitride, cordierite (magnesium-iron-aluminum silicate), mullite (aluminum silicate), zirconia (zirconium oxide), phyllosilicates, or other high-temperature-resistant particles.

14. A product as set forth in claim 1 wherein the layer comprises at least one of epoxy resins, phosphoric acid binding agents, calcium aluminates, sodium silicates, wood flour, or clays.

15. A product as set forth in claim 1 wherein the layer comprises a liquid dispersed mixture of alumina-silicate-based, organically bonded refractory mix.

16. A product as set forth in claim 1 wherein the layer comprises at least one of non-refractory polymeric materials, ceramics, composites, or wood.

17. A product as set forth in claim 1 wherein the layer comprises at least one of alumina or silica particles, a lignosulfonate binder, cristobalite (SiO₂), or quartz.

18. A product as set forth in claim 17 wherein the lignosulfonate binder comprises a calcium lignosulfonate binder.

19. A product as set forth in claim 1 wherein the fibers comprise at least one of ceramic fibers or mineral fibers.

20. A product as set forth in claim 1 wherein the product comprises one of a brake rotor, bracket, pulley, brake drum, transmission housing, gear, motor housing, shaft, bearing, engine, baseball bat, lathe machine, milling machine, drilling machine, or grinding machine.

21. A product as set forth in claim 1 wherein the part comprises a rotor comprising a first brake pad face and a second brake pad face, and an insert positioned between the first brake face and the second brake face.

22. A product as set forth in claim 1 wherein the size of particles in the layer range from about 1 μm to about 500 μm.

23. A product as set forth in claim 1 wherein the layer can withstand a temperature greater than 1300° C.
